(19) United States
(12) Patent Application Publication
(10) Pub. No.: US 2019/0271142 A1
(43) Pub. Date: Sep. 5, 2019

(54) STRAINING APPARATUS

(71) Applicant: Chrome Cherry Limited, London (GB)

(72) Inventors: Pierre Radyn SWART, New York, NY (US); Maxim PYUMAN, London (GB)

(21) Appl. No.: 15/910,181

(22) Filed: Mar. 2, 2018

(51) Int. Cl. E03C 1/264; B01D 29/11

(52) U.S. Cl. CPC E03C 1/264; B01D 2201/4084; B01D 29/114

(57) ABSTRACT

A straining apparatus is provided having a cover and a squat cage member extending normally from an underside of the cover. The cage member has a first end adjacent the cover and a second end configured to fit over a mouth of a drain and support the cover in a spaced relationship relative to the mouth of the drain. The cage member has a sidewall between its two ends with apertures therein to permit flow of liquid whilst hindering passage of solids therethrough and the cover is weighted to hold the straining apparatus substantially in place relative to a drain in use.

### FIELD OF THE INVENTION

This invention relates to a straining apparatus for preventing solid particulates from entering into a drain opening in a bathtub, sink, and the like.

### BACKGROUND TO THE INVENTION

There are a great variety of straining apparatuses in piping systems which prevent solid particulates from entering into a drain opening. An example of such an apparatus is a basket-type strainer in which the flowing medium passes through a basket-like wire mesh, thereby trapping the sediment in the basket. These basket-type strainers are usually unsightly in that the accumulated sediment is visible to the user at all times. Further they are usually difficult to clean and are not very effective as the accumulated sediment may lower the drainage ability of the strainer.

Other known straining apparatuses require the removal of existing drain plug mechanisms in order to be installed and may also require tools for installation.

There is accordingly a need for a straining apparatus that alleviates the abovementioned problems at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with a first aspect of the technology there is provided a straining apparatus comprising a cover and a squat cage member extending normally from an underside of the cover with a first end of the cage member adjacent the cover and a second end of the cage member configured to fit over a mouth of a drain and support the cover in a spaced relationship relative to the mouth of the drain, wherein the cage member has a sidewall between its two ends with apertures therein to permit flow of liquid whilst hindering passage of solids therethrough, and wherein the cover is weighted to hold the straining apparatus substantially in place relative to a drain in use.

A straining apparatus as defined has the advantage of hindering the passage of solids (e.g. loose hair) into a drain thereby preventing build-up of mold and eventual clogging of a drain pipe connected thereto whilst providing a weighted apparatus to provide positioning and stability.

Further features provide for the squat cage member to be tubular and the first end to be a first axial end and the second end to be a second axial end, and wherein the second axial end has an angled rim extending radially outwardly therefrom to form a lip. The angled rim may extend diagonally downwards to form a sharp edge. This has the advantage in that the angled rim may frictionally abut a surface of a drain or a surface surrounding the drain. This may have the added advantage of hindering solids from passing beneath the cage member in use.

Further features provide for the cage member to be secured to the cover by a plurality of securing members projecting radially outwardly from the sidewall of the cage member adjacent the first end for securing the cage member to the cover.

Further features provide for the securing members to provide a snap-fit configuration with a lipped underside of the cover to hold the cage member in place relative to the cover and preventing rotation of the cage member relative to the cover. This may also have the advantage in that, when secured, the lipped underside of the cover may bias the securing members upwards against their normal resting position and thereby holding the cage member in place relative to the cover and preventing any rotation or shift thereof.

Further features provide for the securing members to be radially disposed at intervals around the cage member with the apertures in the sidewall of the cage member provided by a plurality of slots between a plurality of bars provided axially along the sidewall and between the securing members. This arrangement has the advantage in that the bars are sufficiently spaced apart to maximize the flow of liquid through the slots whilst hindering passage of solids therethrough.

Further features provide for the securing members to project radially from only a top portion of the sidewall of the cage member leaving a lower portion of the sidewall for collection of solids. This may have the advantage in that, liquid may flow through the slots provide on the top portion of the surface if the drainage ability of the lower portion is reduced when sufficient solids have collected in the lower portion.

Further features provide for the cover to have a diameter larger than a diameter of the cage member providing an overhang above the sidewall of the cage member and providing a solids collection zone beneath the cover. This may have the advantage in that, solids collected in the collection zone are located beneath the cover and thereby out of sight.

Further features provide for the cage member to be formed of a resiliently flexible material and the cover to be formed of metal providing the weighted cover. The flexibility of the cage member has the advantage of being able to spring back to its original size and shape subsequent to an axially downward pressure on the cover, for example when stepped on by a user. The flexibility of the cage member may also enable removal of the cage member from the cover and also to secure the cage member to the cover.

Further features provide for the resiliently flexible material to be injection molded. This has the advantage in that the cage member is injection molded in a way that avoids any undercuts in portions underneath the securing members. This also has the advantage of the cage member being molded without the use of specialized tooling.

Further features provide for the cage member to be of sufficient circumference and axial length between its two ends to encompass fully in use a drain arrangement with the drain arrangement in open and closed configurations. This has the advantage in that the cage member is of sufficient circumference length to accommodate drains of different sizes. For example, the cage member may have a circumference length greater than the outer diameter of an outer surround of the drain.

Further features provide for the second end of the cage member to be configured to abut a surface of a drain. This has the advantage in that the angled rim may frictionally abut a top surface of the drain for small sized drains, or may frictionally abut an edge or inner surface of the drain or clip over an outer edge of a mounting ring around the drain for medium to large sized drains.

Further features provide for a suction arrangement to be provided on an underside of the angled rim of the cage member. This has the advantage in that soft materials like silicone can be used with a slightly modified convex hollow shape at the underside of the angled rim of the cage member to make it work with a vacuum suction feature.

Further features provide for when secured, the securing members to be biased upwards against their normal resting position by the lipped underside of the cover thus preventing rotation or shift thereof. This may have the advantage in that when biased against their normal resting positions, the securing members are held under tension against the cover thereby preventing rotation of the cage member relative to the cover.

Yet further features provide for the cover to be of a weight greater than 60 g. The cover may be of a weight preferably in the range 60 g to 120 g and more preferably in the range of 80 g to 85 g. This has the advantage in that the cover surpasses a minimum weight requirement of 60 g but at the same time ensures that the apparatus is light enough for comfortable use by a user.

Still further features provide for the cover to have a domed upper surface. This has the advantage in that the cover may gravity bias solids located thereon towards a surface surrounding the drain in use. This shape may also allow the straining apparatus to appear lower and flatter whilst leaving space underneath the cover for the drain plug mechanics.

Even further features provide for the cage member to be open-ended at its second end.

In accordance with another aspect of the technology there is provided a straining apparatus comprising a cover and a squat cage member secured thereto and extending normally from an underside of the cover, wherein the cage member has a first end adjacent the cover and a second end configured to fit over a mouth of a drain and support the cover in a spaced relationship relative to the mouth of the drain, wherein the cage member is formed of a resiliently flexible material and has a sidewall between its two ends with apertures therein to permit flow of liquid whilst hindering passage of solids therethrough.

Further features provide the cover to be formed of a rigid metal material to provide a weighted cover.

Further features provide the cage member to be attached to the cover by a snap-fit configuration, the resiliently flexible material of the cage member enabling the snap-fit of securing members with a lipped underside of the cover.

In accordance with another aspect of the technology there is provided a straining apparatus comprising a cover and a squat cage member secured to and extending normally from an underside of the cover with a first end of the cage member adjacent the cover and a second end of the cage member configured to fit over a mouth of a drain and support the cover in a spaced relationship relative to the mouth of the drain, wherein the cage member has a sidewall between its two ends with apertures therein to permit flow of liquid whilst hindering passage of solids therethrough, wherein the one or more sidewalls include a plurality of securing members projecting radially outwardly therefrom adjacent the first axial end for providing a snap-fit with a lipped underside of the cover to secure the cage member to the cover.

An example embodiment of the invention will now be described, by way of example only, with reference to the accompanying drawings.

### BRIEF DESCRIPTION OF THE DRAWINGS

In the drawings:

FIG. 1 is an exploded perspective view of an example embodiment of a straining apparatus showing a cover and a cage member separately according to the present invention;

FIG. 2 is a bottom perspective view of the straining apparatus of FIG. 1 with the cage member secured to the cover;

FIG. 3 is a top perspective view of the straining apparatus of FIG. 2;

FIG. 4 is a bottom view of the straining apparatus of FIG. 2; and,

FIG. 5 is a side view of the straining apparatus of FIG. 2.

### DETAILED DESCRIPTION WITH REFERENCE TO THE DRAWINGS

An example embodiment disclosed herein provides a straining apparatus in the form of a cage member extending perpendicularly from a cover. The cover may be one of a variety of geometrical shapes, for example, it may be circular with a domed upper surface or it may be disk-shaped. The cage member may also be one of a variety of geometrical shapes, for example, it may be cylindrical, or oval or hexagonal in cross-section and having a tubular shape along its length. The cage member may be open-ended at one end and may have one or more sidewalls. The cover is weighted to hold the straining apparatus substantially in place relative to a drain in use.

In one embodiment, the cage member may secured to the cover, for example, by means of a snap-fit arrangement. The cage member may be formed separately from the cover and made from a different material. In one described embodiment, the cage member is secured to the cover by means of a plurality of securing members projecting radially outwardly therefrom for securing the cage member to the cover by means of a snap-fit arrangement. The cover may be formed of a heavy material such as metal providing a weighted cover with the cylindrical cage member formed of a resiliently flexible material.

In another embodiment, the cage member and the cover may be formed of the same material either integrally as a single piece or as two or more pieces secured together. For example, the entire apparatus may be formed of a heavy material, such as metal, providing extra weight and strength to the apparatus. If it is made from two or more pieces, the pieces may be secured by means of screw attachments or welding. In another example, the cage member and the cover may be made as a single plastic injection molded piece with an additional weighted member provided over or underneath the cover.

The one or more sidewalls of the cage member may have apertures therein to permit flow of liquid whilst hindering passage of solids therethrough. The apertures may be a plurality of slots between a plurality of bars or may be a plurality of holes provided in the sidewall of the cage member. The straining apparatus may be placed over a mouth of a drain opening in a bathtub, sink, or the like and may be used to prevent solids such as loose hair in a flowing medium from entering into the drain thus potentially clogging a drain pipe connected thereto. The straining apparatus may be placed over an entire plug arrangement or filter provided at a drain opening without removing the plug arrangement or filter and without the use of tools for installation.

A specific example embodiment of the straining apparatus is now described in greater detail with reference to the accompanying figures.

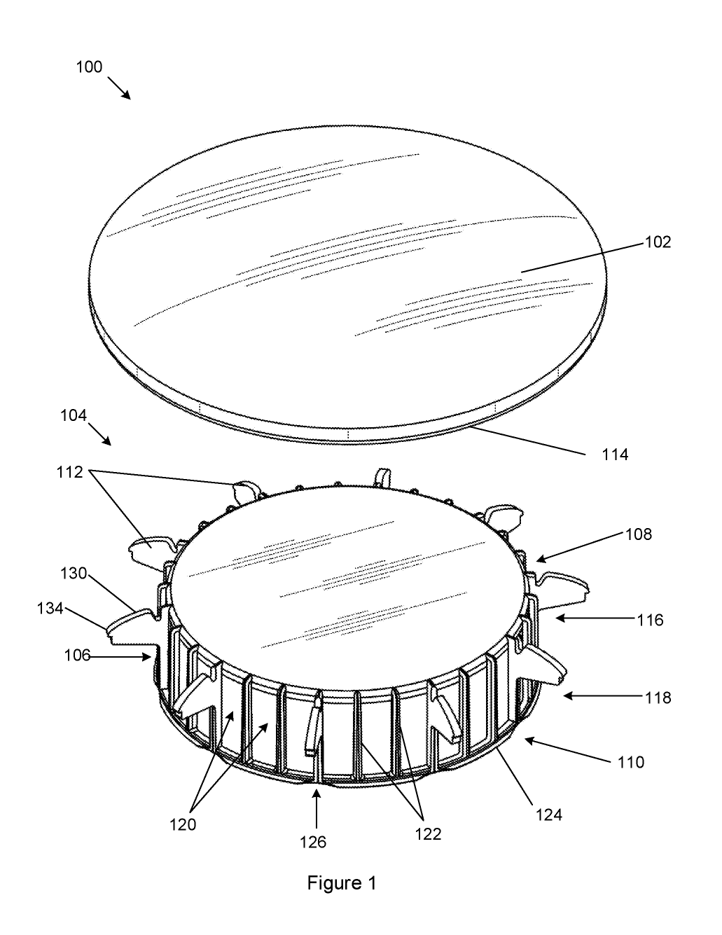

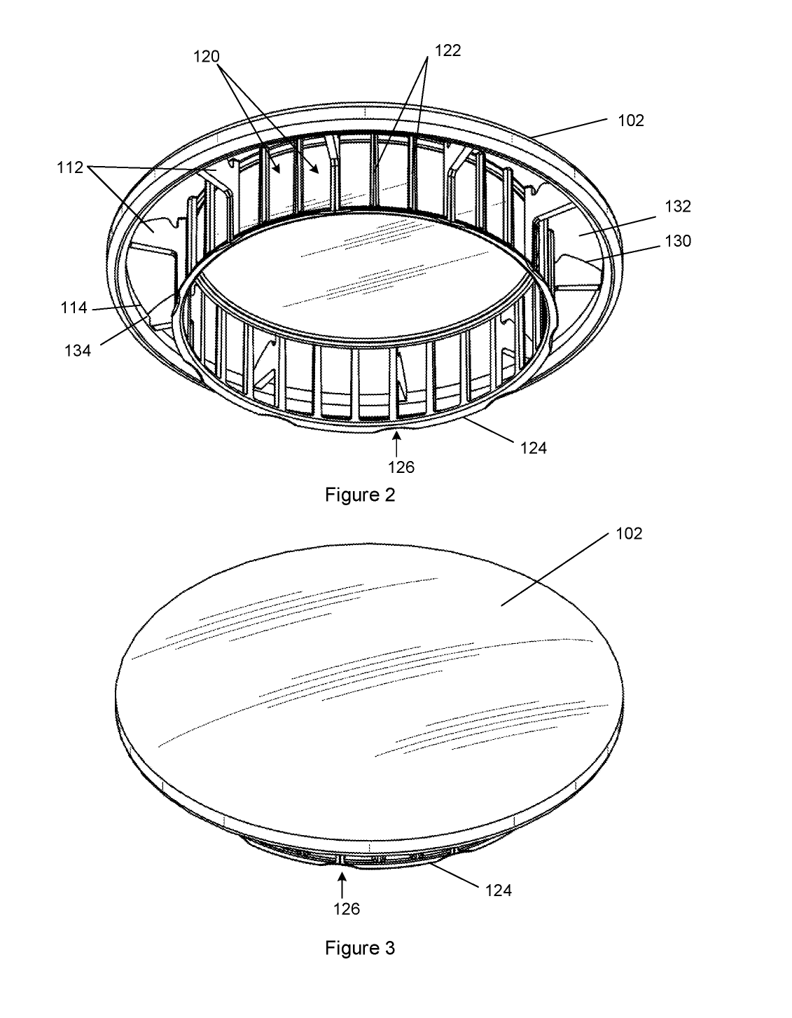

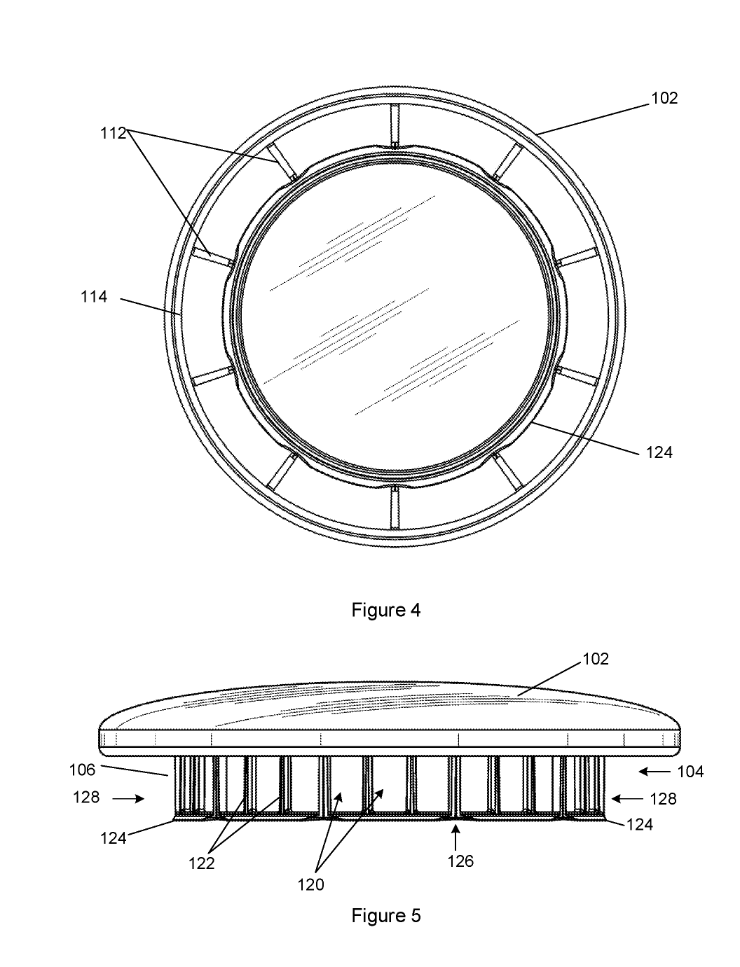

FIGS. 1 to 5 show various views of a straining apparatus (100) according to an example embodiment. The straining apparatus (100) includes a domed cover (102) and a cylindrical cage member (104) removably secured to and extending normally or in a generally perpendicular manner from an underside of the domed cover (102).

The domed cover (102) is formed of metal to provide sufficient downward pressure on the cage member (104). The metal may be any suitable metal and preferably stainless steel. The domed cover (102) may be of a weight greater than 60 g and preferably in the range of 60 g to 120 g and more preferably in the range of 80 g to 85 g. The weight of the domed cover (102) holds the straining apparatus in place by gravity and is sufficiently heavy that it will not readily move from its position over a drain with the force of water or accidental contact by a person.

The cage member (104) is formed of a resiliently flexible material for example a suitable polymer material. The polymer material may be one or more of the group of: Acrylonitrile Butadiene Styrene (ABS), Polypropylene (PP), High Density Polyester (HDPE), Thermoplastic Polyurethane (TPU), Polycarbonate (PC), Polyethylene (PE), Silicone, Rubber A80-90, and Nylon. The resilient flexibility of the cage member (104) enables it to deform and absorb a force, for example, from a person stepping on it or another object resting on it, whilst recovering back to its original shape when the force is removed.

The cage member (104) has a sidewall (106) with a first axial end (108) adjacent the domed cover (102) and a second axial end (110) at an open end of the cage member (104).

A plurality of securing members (112) projecting radially outwardly from the sidewall (106) of the cage member (104) is provided adjacent the first axial end (108) for securing the cage member (104) to the domed cover (102). The plurality of securing members (112) provide a snap-fit with a lipped underside (114) of the domed cover (102) to secure the cage member (104) to the domed cover (102).

The securing members (112) are radially disposed around the cage member (104) and are provided on a top portion (116) of the sidewall (106) leaving a lower portion (118) of the sidewall (106) for collection of solids. A plurality of slots (120) between a plurality of bars (122) are provided axially along the sidewall (106) and between the securing members (112). The bars (122) are sufficiently spaced apart to maximize the flow of liquid through the slots (120) whilst hindering passage of solids therethrough.

The securing members (112) also act as reinforcing ribs that strengthen the cage member (104) and aid in the recovery after a force is applied deforming the resiliently flexible cage member (104).

The second axial end (110) of the cage member (104) has an angled rim (124) extending radially outwardly and diagonally therefrom to form a lip with a sharp edge. The angled rim (124) may frictionally abut a surface of a drain or a surface of a bathtub or sink or may clip over an outer edge of a metal mounting ring around a drain. The angled rim (124) may hinder solids from passing beneath the cage member in use. In one embodiment, a suction arrangement is provided on an underside of the angled rim (124). In one embodiment, a suction arrangement may be provided by the rim being made of silicone with a slightly modified convex hollow shape at its underside to make it work with a vacuum suction feature.

Referring to the view of the straining apparatus (100) shown in FIG. 5, the domed cover (102) has a diameter larger than a diameter of the cage member (104) providing an overhang above the sidewall (106) of the cage member (104) and providing a solids collection zone (128) beneath the domed cover (102). Solids collected on the solids collection zone (128) are therefore located beneath the domed cover (102) and out of sight of a user.

The dome shape aims to maximize a height of the straining apparatus (100) without being too obtrusive when covering a drain and the dome shape helps to keep the straining apparatus (100) in place in a situation where it is stepped on by a user. The dome shape helps sweep hair underneath the cover into the solid collection zone (128). The lipped underside (114) of the domed cover (102) may act as an assembly point and create a smooth curve at the bottom of the cover (102) to help guide debris to the solids collection zone (128) of the cage member (104).

As shown in the view of the straining apparatus (100) of FIG. 2, the securing members (112) are disposed at a vertical distance relative to the first axial end (108) of the cage member (104) and when secured to the domed cover (102), the securing members (112) are biased upwards against their normal resting position by the lipped underside (114) of the cover (102). The securing members (112) may be disposed at a vertical distance of between 0.2 mm to 0.6 mm relative to the first axial end (108) of the cage member (104) and preferably at a vertical distance of 0.3 mm. The securing members (112) are therefore held under tension against the domed cover (102) thereby preventing rotation of the cage member (104) relative to the domed cover (102).

The securing members (112) have pointed tips (134) which are configured to be snap-fitted onto the lipped underside (114) of the domed cover (102) as more fully shown in FIG. 1 and FIG. 2. A recess may be provided on the underside (114) of the domed cover (102) to house the pointed tips (134) of the securing members (112). As shown in the view of the straining apparatus (100) of FIG. 2, the securing members (112) have a top curved surface (130) corresponding to the underside surface (132) of the domed cover (102), and when secured thereto, bears against the underside surface (132).

The cage member (104) is of sufficient axial length between its two ends (108, 110) to support the domed cover (102) in a spaced relationship relative to a mouth of the drain or a surface of a bathtub or sink in use. The cage member (104) is also of sufficient circumference to encompass fully in use a drain arrangement with compatibility with different drain sizes. The cage member (104) may have a diameter in the range 50 mm to 90 mm. The internal space defined by the cage member (104) is designed to house a plug arrangement or filter regardless of its open or closed position, including push-down, rotate or lever plugs.

In use, the straining apparatus (100) is provided with the cage member (104) secured to the domed cover (102). The straining apparatus (100) is placed over a mouth of a drain in a bathtub. In normal use, only the top surface of the domed cover (102) is visible to a user from above. As mentioned above, the cage member (104) is of sufficient length to support the domed cover (102) in a spaced relationship relative to the mouth of the drain. The weight of the domed cover (102) provides sufficient downward pressure on the cage member (104) to keep the straining apparatus (100) in place relative to the drain. Further, depending on the size of the drain opening, the angled rim (124) frictionally abuts a top surface of the drain or frictionally abuts a surface of the bathtub and keeps the straining apparatus (100) in place relative to the drain.

When water or liquid is poured into the drain, for example, when a user showers, water flows through the plurality of slots (120) into the drain. As noted, the bars (122) are arranged such that they only permit water to flow through the slots (120) whilst hindering the passage of loose hair or any other solids therethrough. The angled rim (124) may form a triangular or tapered edge that helps retain debris such as hair on the cage member (104) and prevent debris from sliding off the cage member (104). The angled rim (124) also prevents the debris from getting through underneath the cage member (104). The domed upper surface of the domed cover (102) enables debris located thereon to be gravity biased towards a surface surrounding the drain. The domed cover (102) has a diameter larger than a diameter of the cage member (104) providing an overhang above the sidewall (106) of the cage member (104) and providing a solids collection zone (128) beneath the domed cover (102).

In one use scenario, the straining apparatus (100) may be used in a bath or shower and the debris may be loose hair.

The loose hair accumulates on the sidewall (106) and around the lower portion (118) of the cage member (104) in the solids collection zone (128). The loose hair is therefore located beneath the domed cover (102) and out of sight of the user. It will be appreciated that as the loose hair accumulates in the lower portion (118) of the cage member (104), the drainage ability of the lower portion (118) is reduced. The securing members (112) which project only from the top portion (116) of the cage member (104) ensures the loose hair is collected in the lower portion (118) of the cage member (104). This enables water to flow in the slots (120) provided on the top potion (116) and above the accumulated loose hair when the drainage ability of the lower portion (118) is reduced.

The cage member (104) is formed of resiliently flexible material and is able to spring back to its original size and shape subsequent to an axially downward pressure on the domed cover (102), for example when stepped on by the user.

When sufficient loose hair has accumulated on the cage member (104), the user may remove the straining apparatus (100) from over the mouth of the drain. The user may clean the cage member (104) without the need to remove the domed cover (102) as the diameter of the domed cover (102) is sufficiently larger than that of the cage member (104) to provide access to the first axial end (108) of the cage member (104) adjacent the domed cover (102). However, the flexibility of the cage member (104) permits the user to remove the cage member (104) from the domed cover (102) if additionally required in order to clean the cage member (104). The diameter of the domed cover (102) is such that it is not too large a visual or physical obstruction inside the bathtub.

As noted, in one embodiment a suction arrangement (126) is provided on the underside of the angled rim (124) that may be made of silicone with a slightly modified convex hollow shape at its underside to make it work with a vacuum suction feature.

The cage member (104) may be designed for injection molding in a manner that avoids any undercuts or specialized tooling. Curved cutaway portions (126) shown in FIG. 2 may enable a tool to reach an underside of the securing members (112) without colliding with the angled rim (124) when molding the cage member (104).

The curved cutaway portions (126) may also assist in removing debris from the cage member (104) as a user may move any debris stuck on the angled rim (124) circumferentially towards the curved cutaway portions (126) to remove the debris. This enables more effective and thorough cleaning of the cage member (104).

The straining apparatus (100) of the present disclosure has the advantage of hindering the passage of solids (e.g. loose hair) into a drain thereby preventing build-up of mold and eventual clogging of a drain pipe connected thereto. The solids are collected beneath the domed cover (102) and therefore out of sight of the user. The cage member (104) is formed of a resiliently flexible material while the domed cover (102) is formed of the metal. The metal provides a weighted cover (102) and provides a premium look and feel to the straining apparatus (100). The resiliently flexible material is injection molded in a way that avoids any undercuts in portions underneath the securing members or use of specialized tooling during molding of the cage member (104).

The sharp edge of the angled rim (124) has the advantage of frictionally abutting a surface of a drain or a surface of a bathtub or sink or clipping over an edge of a drain surround and hinders solids from passing beneath the cage member (104). The securing members (112) provide a snap-fit configuration with the lipped underside (114) of the domed cover (102) and this has the advantage in that glue or other adhesive material is not used to secure the cage member (104) to the domed cover (102). The cage member may also be formed integrally with the domed cover as one unit which is more cost effective.

The straining apparatus (100) of the present disclosure also has the advantage of being able to accommodate drains of different sizes. The straining apparatus (100) has the advantage of not requiring complex installation in a drain, as the straining apparatus (100) is simply placed over and around the drain. It is appreciated that a bathtub, sink or basin is funneled shaped towards the drain, therefore weighed objects are gravity biased towards the drain. The straining apparatus (100) has the advantage in that the cover is weighted which makes it self-centering around the drain.

It will be appreciated that numerous variations may be made to the embodiment of the invention and its implementation that is described above without departing from the scope hereof.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A straining apparatus comprising a cover and a squat cage member extending normally from an underside of the cover, with a first end of the cage member adjacent the cover and a second end of the cage member configured to fit over a mouth of a drain and support the cover in a spaced relationship relative to the mouth of the drain, wherein the cage member has a sidewall between its two ends with apertures therein to permit flow of liquid whilst hindering passage of solids therethrough, and wherein the cover is weighted to hold the straining apparatus substantially in place relative to a drain in use.

2. The straining apparatus as claimed in claim 1, wherein the squat cage member is tubular and the first end is a first axial end and the second end is a second axial end, and wherein the second axial end has an angled rim extending radially outwardly therefrom to form a lip.

3. The straining apparatus as claimed in claim 1, wherein the cage member is secured to the cover by a plurality of securing members projecting radially outwardly from the sidewall of the cage member adjacent the first end for securing the cage member to the cover.

4. The straining apparatus as claimed in claim 3, wherein the securing members provide a snap-fit configuration with a lipped underside of the cover to hold the cage member in place relative to the cover and prevent rotation of the cage member relative to the cover.

5. The straining apparatus as claimed in claim 3, wherein the securing members are radially disposed at intervals around the cage member with the apertures in the sidewall of the cage member provided by a plurality of slots between a plurality of bars provided axially along the sidewall and between the securing members.

6. The straining apparatus as claimed in claim 3, wherein the securing members project radially from only a top portion of the sidewall of the cage member leaving a lower portion of the sidewall for collection of solids.

7. The straining apparatus as claimed in claim 1, wherein the cover has a diameter larger than a diameter of the cage member providing an overhang above the sidewall of the cage member and providing a solids collection zone beneath the cover.

8. The straining apparatus as claimed in claim 1, wherein the cage member is formed of a resiliently flexible material and the cover is formed of metal providing the weighted cover.

9. The straining apparatus as claimed in claim 8, wherein the resiliently flexible material is injection molded.

10. The straining apparatus as claimed in claim 1, wherein the cage member is of sufficient circumference and axial length between its two ends to encompass fully in use a drain arrangement with the drain arrangement in open and closed configurations.

11. The straining apparatus as claimed in claim 1, wherein the second end of the cage member is configured to abut a surface of a drain.

12. The straining apparatus as claimed in claim 2, wherein a suction arrangement is provided on an underside of the angled rim of the cage member.

13. The straining apparatus as claimed in claim 4, wherein when secured, the securing members are biased upwards against their normal resting position by the lipped underside of the cover thus preventing rotation or shift thereof.

14. The straining apparatus as claimed in claim 1, wherein the cover is of a weight greater than 60 g.

15. The straining apparatus as claimed in claim 1, wherein the cover has a domed upper surface.

16. The straining apparatus as claimed in claim 1, wherein the cage member is open-ended at its second end.

17. A straining apparatus comprising a cover and a squat cage member secured thereto and extending normally from an underside of the cover, wherein the cage member has a first end adjacent the cover and a second end configured to fit over a mouth of a drain and support the cover in a spaced relationship relative to the mouth of the drain, wherein the cage member is formed of a resiliently flexible material and has a sidewall between its two ends with apertures therein to permit flow of liquid whilst hindering passage of solids therethrough.

18. The straining apparatus as claimed in claim 17 wherein the cover is formed of a rigid metal material to provide a weighted cover.

19. The straining apparatus as claimed in claim 17 wherein the cage member is attached to the cover by a snap-fit configuration, the resiliently flexible material of the cage member enabling the snap-fit of securing members with a lipped underside of the cover.

20. A straining apparatus comprising a cover and a squat cage member secured to and extending normally from an underside of the cover with a first end of the cage member adjacent the cover and a second end of the cage member configured to fit over a mouth of a drain and support the cover in a spaced relationship relative to the mouth of the drain, wherein the cage member has a sidewall between its two ends with apertures therein to permit flow of liquid whilst hindering passage of solids therethrough, wherein the one or more sidewalls include a plurality of securing members projecting radially outwardly therefrom adjacent the first axial end for providing a snap-fit with a lipped underside of the cover to secure the cage member to the cover.
